(19) United States
(12) Patent Application Publication
(10) Pub. No.: US 2002/0065778 A1
(43) Pub. Date: May 30, 2002

(54) Mehtod of and a system for distributing electronic content

(76) Inventors: Stephane Bouet, Tokyo-To (JP); Naoaki Nll, Tokyo (JP)

Correspondence Address: ANTONELLI TERRY STOUT AND KRAUS, SUITE 1800, 1300 NORTH SEVENTEENTH STREET, ARLINGTON, VA, 22209

(21) Appl. No.: 09/725,935

(22) Filed: Nov. 30, 2000

(51) Int. Cl. G06F 17/60

(52) U.S. Cl. 705/57; 380/201; 380/204

(57) ABSTRACT

A terminal device, a memory module, a method and a system for exchanging electronic content. A wireless connection is used for transferring electronic content between wireless terminals according to predetermined tailoring information. The tailoring information defines what electronic content it is possible to exchange between the wireless terminals. The memory module stores the tailoring parameters and is separate from and releasably attachable to one terminal device. That terminal device is adapted to read the tailoring information from the memory module and to transmit the tailoring information to another terminal device over the wireless connection.

### FIELD OF THE INVENTION

The present invention relates to a system and associated method for the electronic sale and distribution of digital multimedia, such as audio or video signals, and more particularly, relates to a system and method in which digital multimedia, including audio or video signals, may be delivered between users having terminals enabling connection therebetween.

### BACKGROUND OF THE INVENTION

Traditionally content, e.g. papers and magazines, is distributed in physical format by multimedia content distributors such content creators, content publishers and retail businesses. An advanced way to transfer movies, music, text, and similar files is through records, tapes, and compact discs, etc. Such items may be bought or rented in shops. These items may easily be traded, loaned, or otherwise “swapped” between friends. Further, devices have been developed for delivering of streaming content such as video, audio and MP3, and the like, and so such file swapping is becoming more attractive. The terminals are coming smaller and smaller, and they can easily be carried everywhere, and so the transferability of digital content is easily done. For example, there are numerous different small, portable models of MP3 players on the market.

Gaining access to information, e.g. digital content, that is available on the Internet conventionally requires a hardware connection to the Internet. While the Internet allows users to access information via any computer or terminal connected to the Internet, the need for a hardware connection presents an undesirable physical limitation to Internet information access—a particular impediment to users who spend a substantial amount of time on the move. To purchase a multimedia presentation, song or video, requires the purchaser or end user to go to a location to purchase the songs or video, e.g. through a delivery point of digital media. As many users are not able to go to such a delivery point to purchase the digital media, it is desirable to obtain digital media through other channels. Thus, the delivery of digital media is desirably not limited to a specific place, but other possible channels are desirable, and particularly an inexpensive way to provide digital media to an end-user is desirable as well. Also, as users become more dependent on information and services provided on the Internet, it is desirable for such information and services to be available to persons who are moving about, and so who may not always have access to a connection to the Internet or to information providers of digital content. Consequently, different systems for and methods of transferring digital content are becoming increasingly important.

Although the Internet is making a breakthrough in the mobile communication world thanks to the introduction of browsers on mobile terminals, it is expected that some alternative models for accessing the content/information on Internet will be needed. Whereas the browser model is heavily based on user interaction, other models where the user can be more passive make particular sense in mobile environments because of potential limitations in the capabilities of some terminals, because of the lack of time for browsing, and because of the importance of accessing information quickly rather than having freedom to surf among the various sources of information available. In this kind of context, a terminal having a passive mechanism will help the user in content downloading, while preferably retaining aspects of a browser based content access model to keep flexibility in what content can be accessed.

Further, an ability to take into account copyright rules needs to be arranged. The copying of digital content, e.g. music, is easily done, and such copying might violate the copyright laws if Digital Rights Management (DRM) technology is not effectively used. Various DRM technologies exist today and are based on more or less complex encryption and decryption schemes, where the necessary keys are created, distributed, and stored in various manners. These solutions are based on the idea that digital content is of no use if it is encrypted and can not be decrypted. Consequently, emphasis is placed on ensuring the robustness of the encryption schemes, rather than on preventing the actual content transfer operation.

Thus, as is apparent from the above discussion, there is a need to provide new services which may effectively use terminals in a controlled way, while taking into account copyright laws. Services which will enable access to wireless terminals are in great demand. Such services will also enable the terminal users to use their terminals efficiently. The present invention provides a solution to the aforementioned and other shortcomings of the prior art, while offering additional advantages over the prior art.

### SUMMARY OF THE INVENTION

To overcome limitations in the prior art such as described above, and to overcome other limitations that will become apparent upon reading and understanding the present specification, the present invention discloses a system, apparatus and method for transferring digital content between wireless terminals operating with a wireless connection, and more particularly in the areas of short range connection. The system provides a terminal the ability to communicate with another terminal in areas of short range connectivity.

In accordance with one embodiment of the invention, there is provided a method of distributing electronic content between terminal devices, which method comprises transferring selected electronic content from a first terminal device to a second terminal device according to predetermined tailoring information, said tailoring information defining what electronic content is able to be transferred between said first and second terminal devices. The method includes storing said tailoring information on a memory module, which is separate from and releasably attachable to at least said second terminal device, attaching said memory module to said second terminal device, and while so attached reading said tailoring information from said memory module into said second terminal device, and transferring electronic content from said first terminal device to said second terminal device according to the tailoring information read from said memory module when attached to said second terminal device.

Further the present invention pertains to a method in which a memory module is releasably attachable to said first terminal device. The method includes attaching said memory module to said first terminal device, and while attached reading tailoring information from said memory module to said first terminal device, transferring electronic content from an access point to said first terminal device according to said tailoring information read from said memory module when attached to said first terminal device, and having received and stored the electronic content at said first terminal device, allowing the electronic content to be transferred to said second terminal device in accordance with the method above.

The present invention discloses a method to adjust and tailor the content that is being delivered through a Push type of information exchange model . The invention enables portability of preferences or settings in order to allow the user to transfer from one terminal to another.

Furthermore, according to an embodiment, the present invention permits control and prevention if needed of digital content forwarding from one user to another without requiring any complex DRM scheme, although this does not exclude DRMs that could be used in combination with an embodiment of the invention. The main advantage is that it does not necessarily require the existence and usage of any DRM technique. The content does not necessarily have to be encrypted for the invention to be applicable. The invention is as efficient with non-encrypted content as it is with encrypted content. The invention is meant for devices that are fitted with IC card readers.

There is no need for browser software in the terminal for receiving files from another terminal. The only active operation the user has to do is insert a card, or information relating to the IC card, into the terminal. The terminal has the benefit of selecting content already downloaded in the terminal. The terminal may have means for surfing off-line within documents received.

In many cases the terminal user does not want to be active and browse. Therefore a process that is automatic and comfortable to use is needed. In order to achieve this, the content still needs to be selected. This is usually done by the user using a browser. According to the invention, IC cards, as a preferred embodiment, are used for storing selection information in the form of parameters, called tailoring parameters, the selection information preferably is stored on the IC card and entered into the terminal from the card.

The method according to an embodiment of the invention comprises enabling a terminal, having an IC card inserted in a card reader, to provide content to be delivered from the terminal to another terminal if the services specified in the IC card and the content match with each other, taking into consideration that the content contains information that was not transmitted to the terminal device previously.

Furthermore, having the IC card inserted into the terminal and a radio frequency (RF) link between the terminals, one of the terminals reads the tailoring parameters through the RF link. The user not having a terminal, but having a card, may get access to content through different terminals of different card owners.

Furthermore, according to the present invention the transfer of tailoring parameters includes a time dependent subscription for the content. Each consumer may purchase the right to listen, read or view digital content for a certain period with charges made against a fee paid on the IC card. Then, automatic downloading between the terminals for the specific content is available during that time period.

Furthermore, according to an embodiment of the present invention the transferred content may include information in digital format. The digital information may include at least one of the following: movies, music, games, electronic magazines, periodicals, newspaper and television news.

Furthermore, according to an embodiment of the present invention the transferred data includes a prepaid amount of the content. The pre-payment may occur on buying the IC card. The IC card includes information identifying the content for which the card is payment, i.e. what content will be exchanged between the terminals.

Furthermore, according to an embodiment of the present invention, a certificate is connected to the goods/services or other content to be delivered between the terminals. The tailoring parameters in the certificate transferred from the IC card are compared with a certificate stored in a register of certificates in one terminal, allowing delivery only if a match occurs between the transmitted and the stored certificates.

Furthermore, according to a further embodiment of the present invention the invention relates to gathering of information on how many media, how much data, and what data are transmitted between the terminals. Thus a count on copyright payments for musical compositions, for example, may be maintained.

According to a third aspect of the invention there is provided a memory module for storing information and for use with a terminal device. The memory module includes a storage medium for storing tailoring information relating to specific electronic content, the tailoring information defining the specific electronic content that the memory module authorizes to be transferable to the terminal device, and an interface for mechanically and electrically coupling the memory module to the terminal device, the memory module being releasably attachable by a user to the terminal device to bring the memory module into mechanical and electrical contact with the terminal device.

According to a fourth aspect of the invention there is provided a terminal device having means for wireless communication. The terminal device includes a storage device for storing tailoring information relating to specific electronic content, an interface for mechanically and electrically coupling the storage device to the terminal device, the interface allowing releasable attachment of the storage device by a user to the terminal device to bring the storage device into mechanical and electrical contact with the terminal device, means for reading the tailoring information from the storage device into the terminal device when the storage device is mechanically and electrically connected to the terminal device, the tailoring information defining specific electronic content that the (storage device authorizes as being transferable to the terminal device, and means for transmitting the tailoring information over the wireless communication in order to receive electronic content by the terminal device according to the tailoring information read from the storage device.

### BRIEF DESCRIPTION OF THE DRAWINGS

These and other objects and features of the invention will become more apparent from the preferred embodiments described with reference to the attached drawings, which are for the purposes of illustration and not for limiting the invention. In the drawings:

FIG. 1 is a block diagram of a terminal in accordance with an embodiment of the invention,

FIG. 2 is a block diagram of an embodiment of an IC card according to the invention,

FIG. 3 illustrates an embodiment of a method for two Bluetooth devices to operate when establishing a connection in accordance with the invention,

FIG. 4 illustrates communication between two terminals in accordance with an embodiment of the invention,

FIG. 5 is a block diagram of a terminal in accordance with another embodiment of the invention,

FIG. 6 is a block diagram of a semi hardware tamper resistant module in accordance with an embodiment of the invention,

FIG. 7 illustrates in more detail an identification packet in accordance with an embodiment of the invention, and

FIG. 8 illustrates an example of the data stream structure in accordance with an embodiment of the invention,

### DETAILED DESCRIPTION

In the following description of the various embodiments, reference is made to the accompanying drawings which form a part hereof, and in which are shown by way of illustration various embodiments in which the invention may be practiced. It is to be understood that other embodiments may be utilized, and structural and functional modifications may be made without departing from the scope of the present invention.

This invention proposes a way for the transfer of digital content from one user to another user under the control of IC cards. In this invention, each user has a terminal that is fitted with an IC card slot. In the terminal of the user who wishes to initiate the transfer, there is, locally stored, some digital content. For the transfer of this content to the other user to be allowed, IC cards that give the right to transfer and receive the above content must be inserted on both terminals.

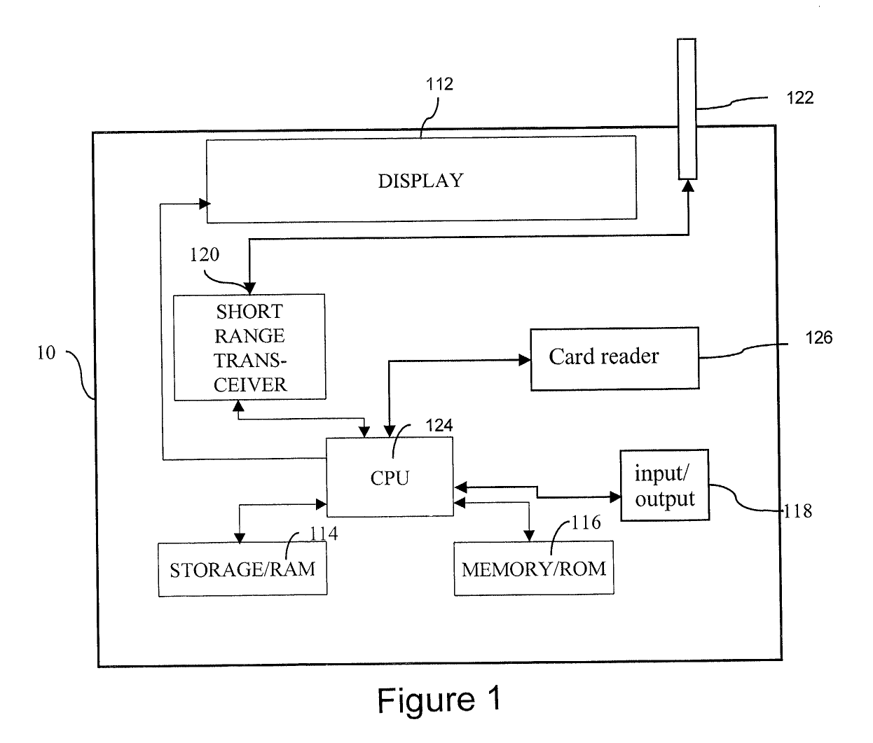

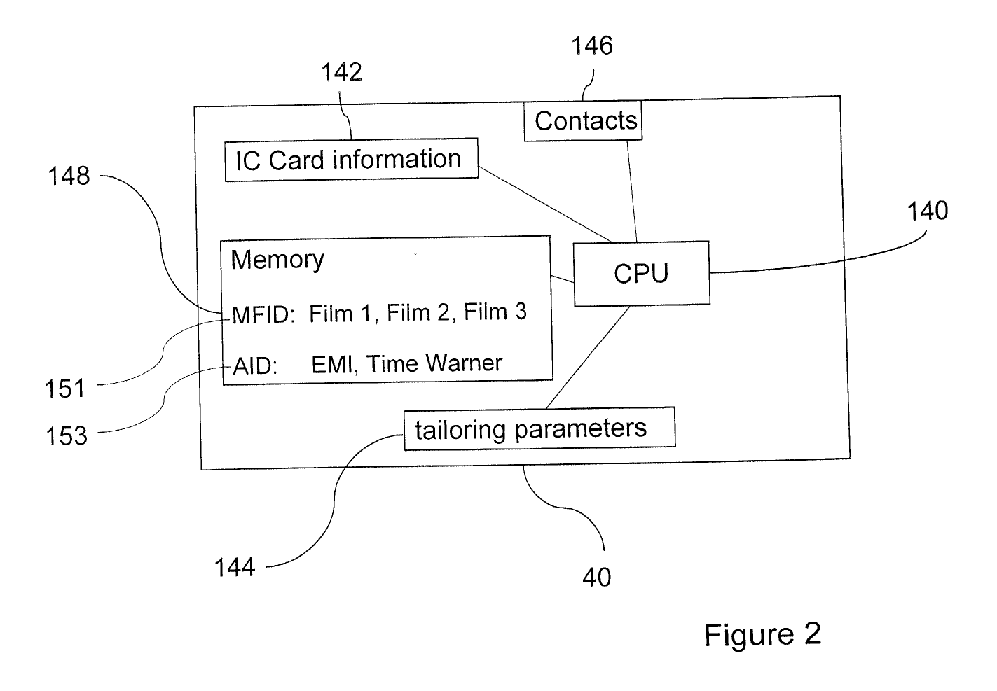

FIG. 1 depicts in a block diagram a terminal 10 in accordance with an embodiment of the invention. The terminal 10 comprises a display 112, a random access memory (RAM) 114, a read only memory (ROM) 116, an output/input unit 118, such as keypad e.g. for entering text etc., a RF transceiver 120 for communication with other transceivers, e.g. transceivers in other terminals, an antenna 122, and controller or CPU 124 for controlling the various functions of the terminal. Neither a conventional telephone keypad nor a QWERTY keypad is a requirement, as the user needs, in the preferred embodiment, only to accept files for downloading, make selections from the downloaded items, and possibly browse in the downloaded information. Thus instead of a full keypad, only a key with the functionality to control the above operations is required. Further in a preferred embodiment of the invention the terminal may have a card reader 126. CPU 124 controls the card reader 126. Further the terminal typically includes a battery pack (not shown) for power supply. Preferably, but not necessarily the transceiver 120 enables short range, low power RF communication, like Bluetooth, with another terminal. The terminal 10 may have a slot (not shown) therein to receive an IC card 40 (FIG. 2) in the card reader 126.

IC cards or electronic chip cards are usually the size of a conventional credit card and have six or eight electrical contacts on one face and include an integrated circuit with a memory, and may include microprocessors. Data and programs for manipulating the data and communicating outside the card are included in the integrated circuit. In the past the cards, such as prepaid cards have been widely used in the purchase of telephone service, particularly in France and Germany, where public pay telephones accept the prepaid cards instead of coins. Typically the prepaid cards are purchased at a post office for a specific amount. The cards are inserted in a public pay telephone, connection is made through the contacts and units of value are removed from the card as the telephone call progresses. The mechanical and electrical specifications of the cards are standardized, and one set of standards is published by the ANSI (American National Standards Institute), 11 West 42 Street, New York, N.Y. 10036 under the title “Identification cards-Integrated circuit(s) cards with contacts” ISO 7816-1 and ISO 7816-2. Smart cards have been manufactured and are commercially available from several companies including e.g. GEMPLUS Card International, Avenue du Pic de Bertagne, Parc d'activites de la Plaine de Jouques, 13420 Gemenos, France.

Once the prepaid card has been consumed, i.e. all of the units or value of the card have been used conventionally in calls, the user has to buy another card or to refill the empty card to continue with the service. The IC card which is purchased in advance and which is inserted into a terminal may be active as soon as it has been purchased. The activity of the card may be given for only a certain period of time. Thus the activity depends on the time limits given to the card.

In FIG. 2 an IC card 40 such as described above is depicted. IC card 40 includes a CPU 140, a smart card identification code such as a serial number 142, a tailoring parameters register 144, and contacts 146 for enabling mechanical and electrical contact with card reader 126 in terminal 10. Tailoring parameters 144, including a card ID, are stored in the IC card memory 148. The card validity might be based on a fee paid periodically, such as monthly or annually. After the paid amount is received, the corresponding entry is made in a validity register.

With regard to the various elements of the IC card as being on an integrated circuit, the microprocessor 140 and several registers 151 or 153 may be all contained within a single chip. Also the information need not be allocated to unique spaces within the IC card memory. For example, the various numbers in the registers may be moved around under the control of the microprocessor 140. This would be in accordance with the design of the particular IC card chip. The serial number of the IC card and possible other functions like time and dates of validity may be written into the integrated circuit at the time of manufacture, or subsequent to manufacture. Any convenient or conventional type of circuit and method for the entry of such data may be used.

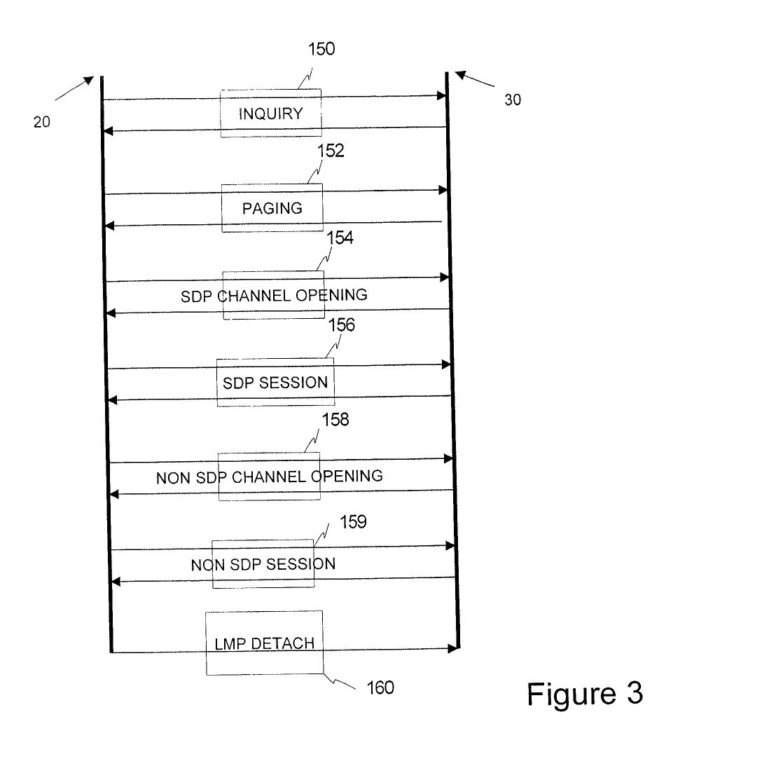

FIG. 3 illustrates one embodiment a method for two Bluetooth devices 20, 30 to operate when establishing a connection. The first Bluetooth device 20 takes the initiative and regularly performs inquiries to discover surrounding Bluetooth terminal devices such as device 30. During the first phase of the process, the first Bluetooth device 20 and the other Bluetooth device 30 form a first Bluetooth connection, thus forming a piconet. The following steps are involved in forming a piconet: As is known from the Bluetooth specification, first inquiries 150 are executed for establishing a connection. After successful completion of inquiries, paging 152 is activated. After paging a Service Discovery Protocol (SDP) channel is opened 154, and the SDP session starts 156. All necessary information for establishing a Bluetooth connection is gathered, including but not limited to e.g. the other Bluetooth device's baseband address, and clock offset information from the inquiry mode, the Bluetooth class of the other Bluetooth device and supported services information of the devices from the SDP mode. After the information is gathered, a non-SDP nature channel 158 can be opened for Bluetooth communication between the devices 20, 30. Available channels in the Bluetooth protocol architecture are illustrated and can be found in more detail in the Bluetooth specifications. When the communication between the Bluetooth devices 20, 30, is to be concluded, the first Bluetooth device 20, or the second Bluetooth device 30, sends a Link Manager Protocol detach message 160 that terminates the session between the devices 20, 30.

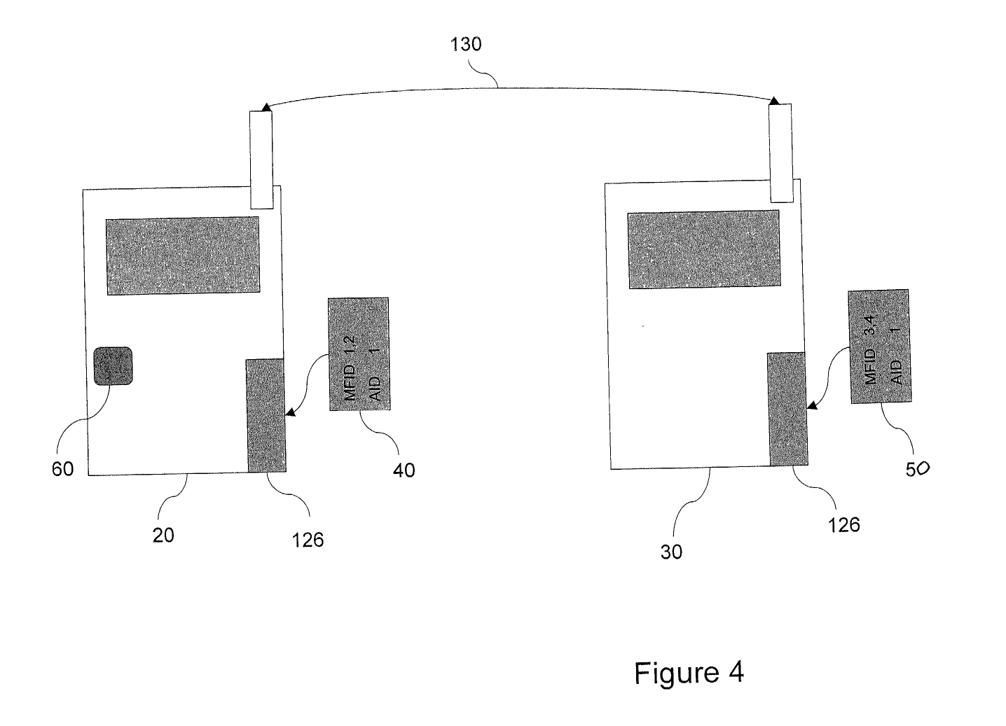

Once a consumer utilizes multimedia file(s) on his or her own wireless personal multimedia terminal, after receiving such file(s) properly, he or she might want to forward such file(s) to another user, i.e. a friend. The following conditions may be imposed for user to user distribution between compatible user terminals. In a first step an IC card 40 is inserted in the sender wireless terminal 20, as depicted in FIG. 4. The user selects and activates the “file forward” function mode of wireless terminal 20. The above two steps can be done in the opposite sequence, if desired. Wireless terminal 20 checks the user multimedia database and application identifications (AIDs) 153 (FIG. 2) of the inserted IC card 40. Card 40 then presents a list of multimedia file identifiers (MFIDs) 151 of multimedia data, or part of the MFIDs 151 (e.g. just the titles of the files), which are authorized to be forwarded to another authorized user terminal 30. The user selects and marks the multimedia file(s) 60 that he or she choses to be ready for forwarding to the other authorized user terminal 30. Wireless terminal 20 activates its wireless interface system and looks for the other terminal 30. The recipient user terminal 30 has inserted into its card reader 126 an IC card 50 containing the same AID(s) 153 as specified in the multimedia file(s) 60 to be forwarded. The recipient user selects and activates the “file receiving” function mode of terminal 30. The above two steps can be done in the opposite sequence, if desired. The recipient terminal 30 activates its wireless interface system and a communication link 130 is formed between the two terminals 20, 30. The sender terminal 20 matches the AID(s) 153 of the MFID list 151 which are marked as authorized for forwarding and the AID(s) 153 presented by the recipient wireless terminal 30. This authority of relevant multimedia is set in the MFID 151 as defined in one embodiment of this invention. The sender terminal 20 reads the MFID(s) 151 stored in the user multimedia database of recipient terminal 30 and matches these MFID(s) 151 to the MFIID(s) stored in the user multimedia database of the sender terminal 20 which are marked to forward. If the recipient terminal 30 already stores the same MFID(s), such overlapped multimedia file(s) 60 are unmarked from the list of MFID(s) for forwarding. Then the marked multimedia file(s) 60 are downloaded from sender wireless terminal 20 to recipient terminal 30 automatically. The sender terminal 20 then shuts down wireless interface connection.

This invention implements an additional authentication method on top of the short range wireless interface standard. The link 130 between the terminals 20 and 30 is established based on authentication maintained during a single integrated procedure. If the link 130 is broken, it is required that the whole procedures be restarted. This requirement enhances the security of the system.

The second condition for authorization for the transfer to actually take place is that there must be a match between the content for which the IC card 40 inserted in the receiving terminal 30 gives reception authorization and the content that is to be sent. Reception authorization can be linked to the type of content and/or the distributor of the content and/or the author of the content, as examples. Before the transfer operation can actually take place, the sender terminal must read the reception authorization stored on the IC card 40 that is inserted in the sender terminal, and check whether there is a match between the content to be sent and the authorization carried by the IC card that is inserted in the receiving terminal. Thus, the sender terminal must be authorized to send the file, and the recipient terminal must be authorized to receive the file, although either one of these could be omitted.

The invention would fit very well in systems where content transfer is carried out over a Bluetooth link. In such a case, reception authorization information like the AID present in the IC card that is inserted in the receiving terminal 30 could be copied into a Bluetooth Service Record and queried by the sender terminal 20 using a standard Bluetooth Service Record operation after the connection 130 between the two terminals is established. Upon completion of this query, and provided the reception authorization is found and the forwarding authorization and the content to forward match, content forwarding could advantageously take place using the Bluetooth File Transfer profile. The users need matching cards and matching content. This should be described in the user manual of the product and would be very easy to check. If there are multiple matching AIDs contained in multimedia files stored in the wireless terminal and in an IC card inserted in the wireless terminal, the wireless terminal can execute such multimedia files designated by the AIDs in either of two ways—execute relevant multimedia files automatically in a certain order, or provide a list of AIDs at the display for multimedia file selection by user.

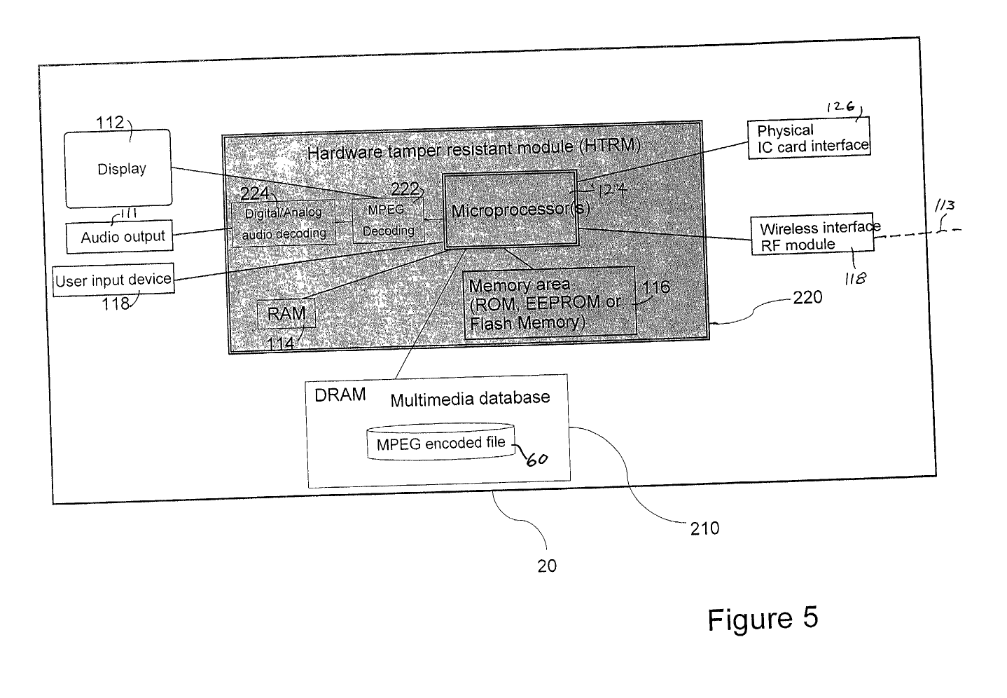

FIG. 5 illustrates an embodiment of a dynamic random access memory (DRAM) according to the invention. Wireless terminal 20 stores multimedia files 60 in a DRAM of multimedia database 210. MPEG decoding unit 222 and audio digital/analog decoding unit 224 are maintained in a hardware tamper resistant modules (HTRM) 220. Transceiver 120, microprocessor(s) 124, and ROM or flash memory area 116 are also in the HTRM 220. The embodiment of the wireless terminal of this invention has common authentication and key management schemes in HTRM 220. The electronic power for DRAM 210 is supplied through HTRM 220 of the wireless terminal. Therefore, when the DRAM 210 is detached from HTRM 220, multimedia file(s) 60 stored in the DRAM 210 are automatically erased.

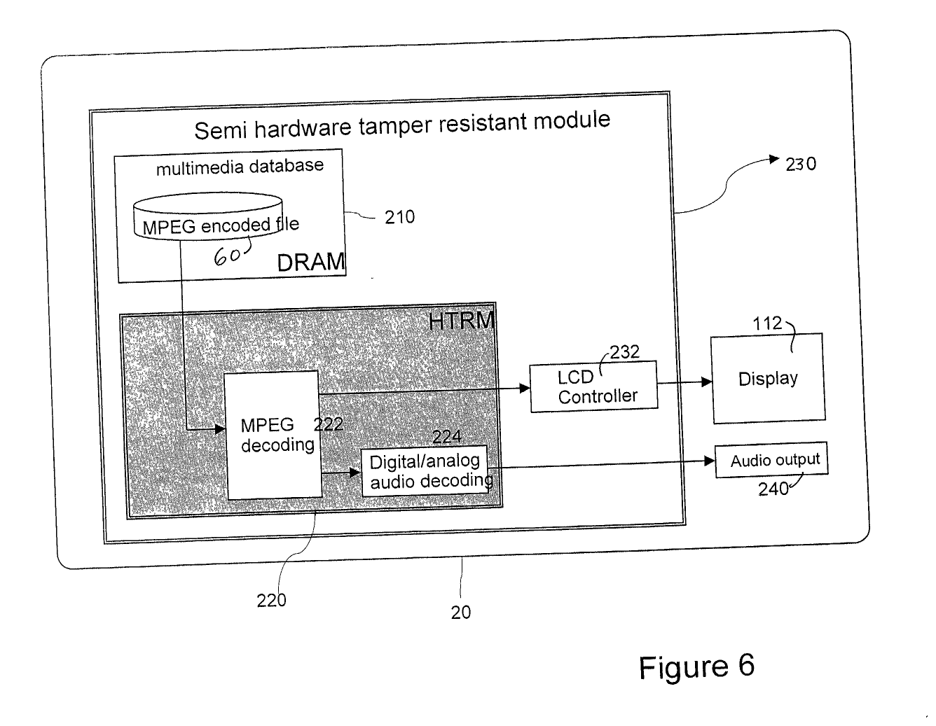

When the multimedia file content format is MPEG encoded video, the following procedure may be utilized. As depicted in FIG. 6, in the HTRM 220, MPEG decoding unit 222 applies an output to digital to analog audio decoding unit 224 and an output to LCD controller 232, DRAM 210 and LCD controller 232 may be configured as a semi HTRM 220, mechanically attached and chemically glued to HTRM 220.

Each HTRM 220 in this embodiment of the invention stores a common secret algorithm, a random number generation system (RAND), a unique public key and a unique secret (private) key. These elements are programmed securely into the HTRM in a secure environment and through secure processes.

The authorization information may indicate a specific multimedia file, a group of multimedia files, a category of multimedia files, a maximum number of multimedia files, or a maximum value of multimedia files that the users are authorized to exchange, whether to audio output device 111, video display device 112, or via user output interface 118 to a magnetic media output device coupled by link 113. By exchanging is meant providing information between terminals in audio format via audio output device 111, providing information in video format via display device 112, or providing information in electronic format via link 113.

In a wireless environment, one embodiment of the invention may be using a Bluetooth connection between terminals. When doing an inquiry after an IC card is inserted and the short range connectivity status is selected from the menu by pushing a button on the terminal, the sender terminal might detect several other terminals. A mechanism to distinguish the Master from the Slave is described now. If an IC card is simply introduced into a terminal without any other interaction, the terminal goes into a inquiry scan, i.e. listens for inquiry packets from other terminals. This happens on a terminal that wishes to receive content. This is a slave terminal. On a terminal that wishes to send content, the IC card must be introduced, and the user perform an additional triggering action, e.g. by selecting from a menu a “forwarding” option. Then the terminal goes into an inquiry mode, i.e. the terminal sends out inquiry packets to terminals located inside its connectivity range. Then the terminal acts as a Master.

To enable identification of a terminal, a special inquiry mechanism is utilized, enabling the terminal that is receiving an inquiry to automatically know that the inquiry is coming from a terminal device specific to an application.

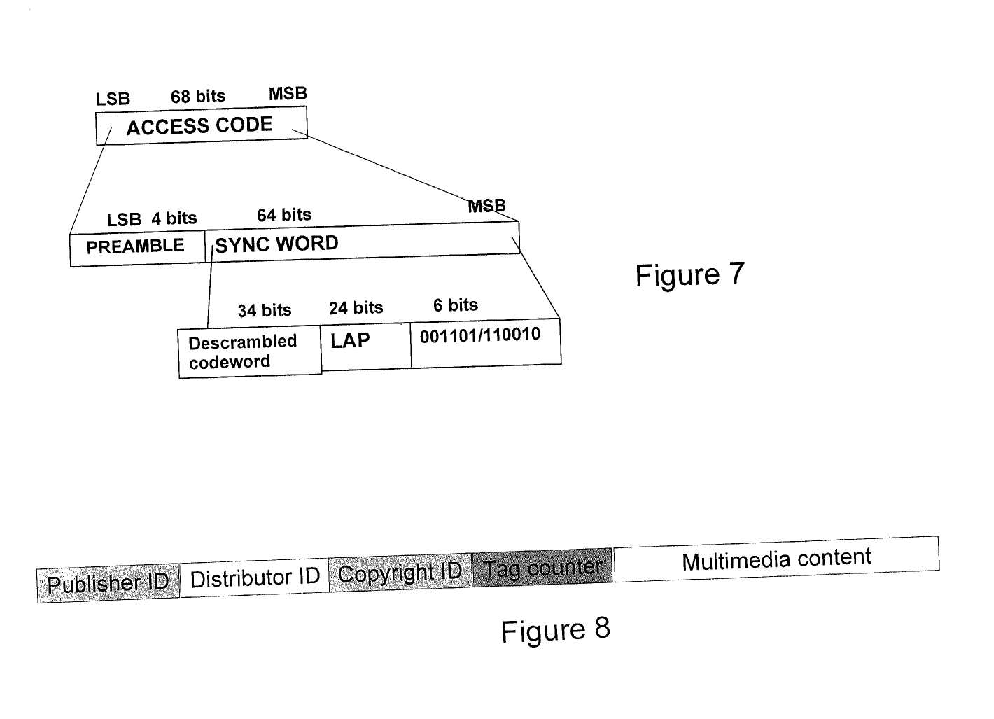

An access code is used in paging or inquiry procedures. Before Bluetooth emission including payload and header information takes place on the recipient terminal, the access code is sent at the inquiry request stage. FIG. 7 presents in more detail the ID packet including the access code. The access code consists of a preamble, a sync word, and possibly a trailer. The Inquiry Access Code (IAC) is sent from a master terminal 20 to a slave terminal 30 at regular intervals. The IAC message does not include a trailer. Thus, the message content is 68 bits long. Different access code types (for example Channel Access Code COC, Device Access Code DAC, General Access Code GIAC and Dedicated Access Code DIAC) use different Lower Access Parts (LAPs) to construct the synchronisation word. The LAP is the 24 lowest bits of the Bluetooth transceiver address, which is a unique 48-bit Bluetooth device address (BD_ADDR). The device access code is used during page, page scan and page response subsets. The LAPs, when used in inquiry packets are used as device type identifiers, i.e. to identify the type of device that should reply to the inquiry request messages.

If the terminal device is only responding to a specific inquiry mechanism, then it is not disturbed by other normal Bluetooth devices doing inquiries, which in turn has a positive effect on the battery life in that fewer inquiry response packets are sent. A terminal device “energy saving” option that can be selected switches the terminal from normal inquiry mode to special inquiry mode, and the other way around.

It is possible to narrow down the list to the predetermined terminals by reading the SDP databases of the various devices automatically, or the whole list of discovered devices may be displayed to the user. Inquiry means also exist to narrow down the search quite efficiently. Using one should be enough to avoid very uncomfortable user interface effects such as having to display 100 devices names. Each device in the list is represented by a human readable name. The list may be set by default in the terminal device and can be customized by the user. Then the user of the sender device will select the device to which it wants to send content.

In the case in which the user wants to send the same content to more than one device, the user interface level can be enabled by check boxes, i.e. in the list of inquired devices, there will be check boxes that the user can select and deselect. When boxes are selected, the sending process is repeated as many times as there are devices to serve without any further user interaction. This is not broadcasting, i.e. sending the same content simultaneously to multiple users, but is a series of point to point individual sending operations. The sending terminal may start to send files one after another after selection. If a file is already locally stored on the receiver terminal, the first packet that sends the first chunk of the file to the receiver terminal is refused. Then an error message, is sent including a corresponding error code, such as “data already present”. Upon reception of this, the sending terminal goes on to the following file to send, and this is repeated until the end of the list of files to send.

IC cards 40 inserted in the terminals may have specific information. The IC card of a sender terminal may have a publisher identity code (P-ID) as an AID which is stored on the IC card and which the microprocessor reads to the receiver terminal memory. The sender terminal may have a similar publisher identity code read from its IC card to its terminal memory. If both the sender terminal and recipient terminals include an IC card having the common tailoring parameters, such as the same publisher identity (P-ID=A), or distributor identity (D-ID=B), or copyright identity (C-ID=C) then the exchange of files is possible.

An example of the data stream structure of an embodiment of the invention is illustrated in FIG. 8. The identities may include information such as a maximum number of multimedia files, or a maximum value of multimedia files, or maximum number of times that the sender terminal is authorized to send multimedia files to a recipient terminal. The sender terminal may forward the relevant data files specific to the publisher, distributor or copyright owner to recipient terminals according to the data recorded in the IC card and saved in the terminal device. The maximum times that the sender terminal is authorized to send multimedia files to another terminal means that a limited number of forwardings is recorded in the respective file. One possible way to implement this is to add-on to the multimedia file structure like a Forwarding Tag. It may not be possible to forward data files from one user terminal to another, if the respective tailoring parameters do not match. Tags usually describe very simple pieces of information that fit within a bit (boolean), or a byte at most. In that case, it is necessary to add to the multimedia file one byte of information that counts the number of forwardings of this file that are possible (e.g. from 0 to 255). The Tag value is updated after each forwarding, until the maximum number of forwardings, and further forwardings of the file are prevented.

One way to determine whether it is possible to transfer content between devices is to see whether the content already exists in the receiving terminal device. Another way of doing it is simply to try to send the content and see whether it is accepted or whether an error message “e.g. already stored,” is returned. The invention enables delivery of content through short range communication between matched terminals. Useless overwriting of content is prevented by a receiving terminal that refuses already locally stored content.

The so called OBEX or Object Exchange protocol can be used as a transport mechanism for the tailorization parameters between the IC card and the receiving terminal device. OBEX is rather flexible and simple and can be used within the framework of one of the existing Bluetooth profiles, in case the process of retrieving tailorization parameters shall be open to just any Bluetooth terminal in the future.

It will be apparent, therefore, that the illustrative embodiments described are only examples, and that various modifications can be made in the construction, method and arrangement within the scope of the invention. The present invention is capable of implementation in many forms, all of which utilize compatability between two users to exchange downloading of multimedia files. Although the invention has been described and depicted with reference to preferred embodiments, these are illustrative only, and rearrangements, alterations, and substitutions might be made, with the result still being within the scope of the invention.

1. A method of distributing electronic content between first and second terminal devices, said method comprising the steps of:
(a) storing the tailoring information in a memory module separate from and releasably attachable to at least the second terminal device;
(b) attaching the memory module to the second terminal device;
(c) while the memory module is attached to the second terminal device, reading the tailoring information from the memory module into the second terminal device; and
(d) transferring electronic content from the first terminal device to the second terminal device according to the tailoring information read from the memory module into the second terminal device.

2. A method according to claim 1, wherein the memory module is releasably attachable to the first terminal device; and said method further comprises:
attaching the memory module to the first terminal device;
while the memory module is attached to the first memory module, reading the tailoring information from the memory module into the first terminal device; and
transferring electronic content from an access point to the first terminal device according to the tailoring information read from the memory module into the first terminal device.

3. A method according to claim 1, wherein:
before step (d) the method further comprises the additional step of transmitting the tailoring information from the second terminal device to a third device over a radio frequency link; and
step (e) comprises transferring the electronic content to the second terminal device over the radio frequency link.

4. A method according to claim 3, wherein the radio frequency link is a short range communication radio frequency link.

5. A method according to claim 4, wherein the method further comprises:
causing the first terminal device to enter the coverage area of the second terminal device;
sending an inquiry from the second terminal device to the third terminal device;
sending a response to the inquiry from the third terminal device to the second terminal device;
transmitting the tailoring information to the third terminal device, and
transferring the electronic content from the first terminal device to the third terminal according to the tailoring information received from the second terminal device.

6. A method as claimed in claim 3, further comprising:
automatically transferring new electronic content from the first terminal device to the second terminal device, the new electronic content fulfilling the tailoring information requirements and being determined to not have been transferred to the terminal device earlier.

7. A method as claimed in claim 1, wherein the tailoring information includes time dependent subscription period information defining a time period within which electronic content may be transferred to the second terminal device.

8. A method as claimed in claim 7, wherein the electronic content includes copies of a periodically published item.

9. A method as claimed in claim 1, wherein the memory module is an integrated circuit card.

10. A method as claimed in claim 9, wherein that the method further comprises:
transferring a serial number of the integrated circuit card to the first terminal device;
checking the validity of the integrated circuit card based on the serial number; and
in response to a determination that the integrated circuit card is valid, transferring the electronic content to the second terminal device.

11. A method as claimed in claim 1, wherein the electronic content is electronic goods.

12. A method as claimed in claim 11, wherein the electronic content is at least one selected from the group consisting of movies, music, games, electronic magazines, periodicals, newspaper, and television news.

13. A method as claimed in claim 11, wherein the electronic content includes a series of movies.

14. A method as claimed in claim 1, wherein the electronic content is in the form of electronic services.

15. A system for distributing electronic content, comprising:
a wireless connection for transmission of electronic content;
an element for transferring selected electronic content over the wireless connection according to predetermined tailoring information defining electronic content eligible to be transferred from the element;
a terminal device for receiving electronic content over the wireless connection;
a memory module for storing the tailoring information, the memory module being separate from and releasably attachable to the terminal device;
attaching means for attaching the memory module to the terminal device;
the terminal device being adapted to read the tailoring information from the memory module and to transmit the tailoring information to the element over the wireless connection, and
the element being adapted to transfer electronic content to the terminal device over the wireless connection according to the tailoring information.

16. A memory module for use with a terminal device, said memory module comprising:
a storage medium for storing tailoring information relating to specific electronic content that the memory module authorizes to be transferrable to the terminal device; and
an interface for mechanically and electrically coupling the memory module to the terminal device, the memory module being releasably attachable by a user to the terminal device to bring the memory module into mechanical and electrical contact with the terminal device.

17. A memory module as claimed in claim 16, wherein the memory module is an integrated circuit card.

18. A memory module as claimed in claim 17, wherein the memory module comprises a storage medium for storing electronic money to be used for payment for the specific electronic content.

19. A terminal device comprising:
a storage device for storing tailoring information relating to specific electronic content;
an interface for mechanically and electrically coupling the storage device to the terminal device, the interface allowing releasable attachment of the storage device by a user to the terminal device to bring the storage device into mechanical and electrical contact with the terminal device;
means for reading the tailoring information from the storage device into the terminal device when the storage device is in mechanical and electrical contact with the terminal device, the tailoring information defining specific electronic content that the storage device authorizes as being transferrable to the terminal device;
a transceiver for transmitting the tailoring information by wireless communication in order to authorize transfer of the specific electronic content to the terminal device.
